(19) United States
(12) Patent Application Publication
(10) Pub. No.: US 2017/0163555 A1
(43) Pub. Date: Jun. 8, 2017

(54) VIDEO FILE BUFFERING METHOD AND SYSTEM

(71) Applicants: LE HOLDINGS (BEIJING) CO., LTD., Beijing (CN); LECLOUD COMPUTING CO., LTD., Beijing (CN)

(72) Inventor: Hongfu LI, Beijing (CN)

(21) Appl. No.: 15/246,157

(22) Filed: Aug. 24, 2016

Related U.S. Application Data
(63) Continuation of application No. PCT/CN2016/088860, filed on Jul. 6, 2016.

(30) Foreign Application Priority Data
Dec. 7, 2015 (CN) 201510888100.7

(51) Int. Cl. H04L 12/925; H04L 29/06

(52) U.S. Cl. CPC H04L 47/722; H04L 65/4069

(57) ABSTRACT

The disclosure provides a video file buffering method, system and non-transitory computer-readable medium. The method includes: acquiring video file information, the video file information including at least metadata, generating assistant transcode data corresponding to a video file, the assistant transcode data including at least an index file needed for transcoding the video file into a Transport Stream (TS) stream file, and buffering the acquired video file information and the corresponding assistant transcode data.

### CROSS REFERENCE TO RELATED APPLICATIONS

This application is a continuation of International Application No. PCT/CN2016/088860, filed on Jul. 6, 2016, which is based upon and claims priority to Chinese Patent Application No. 201510888100.7, filed on Dec. 7, 2015, the entire contents of both of which are incorporated herein by reference.

### TECHNICAL FIELD

The embodiments of the present disclosure relate to the field of network technology, and in particular to a video file buffering method and system.

### BACKGROUND

With the development of the Internet technology, it has become common to obtain abundant comprehensive network video resources via Internet. Video websites, which provide video resources, may not only store a large amount of video resources but also accept a significant amount of video access requests every day. Therefore, it is important to store video resources effectively, so as to provide better video services for users. Currently, online video files on many video websites use the MP4 file format. Because MP4 video files can be played by a Flash plug-in, high-definition MP4 videos can be played by a browser as long as the browser supports Flash. Consequently, MP4 has become the current mainstream video format. Given the same video coding rate, a MP4 file has a higher definition and a higher compression quality. A standard MP4 file typically includes an index region and a data content region.

### SUMMARY

Embodiments of the present disclosure provide a video file buffering method, system and non-transitory computer-readable medium.

In one aspect, the embodiments of the present disclosure provide a video file buffering method. The method may include: acquiring video file information of a video file to be buffered, the video file information including at least metadata, generating assistant transcode data corresponding to the video file to be buffered, the assistant transcode data including at least an index file needed for transcoding the video file to be buffered into a Transport Stream (TS) stream file, generating a video buffer file, based on the video file information and the assistant transcode data, and writing the video buffer file into a memory.

In another aspect, the embodiments of the present disclosure provide a video file buffering system. The system may include: at least one processor, and a memory communicably connected with the at least one processor for storing instructions executable by the at least one processor, wherein execution of the instructions by the at least one processor causes the at least one processor to: acquire video file information of a video file to be buffered, the video file information including at least metadata, generate assistant transcode data corresponding to the video file to be buffered, the assistant transcode data comprising at least an index file needed for transcoding the video file to be buffered into a TS stream file, generate a video buffer file, based on the video file information and the assistant transcode data, and write the video buffer file into a memory.

In an additional aspect, the embodiments of the present disclosure provide a non-transitory computer-readable storage medium storing executable instructions for buffering a video file. The executable instructions, when executed by a processor, cause the processor to: acquire video file information of a video file to be buffered, the video file information comprising at least metadata, generate assistant transcode data corresponding to the video file to be buffered, the assistant transcode data comprising at least an index file needed for transcoding the video file to be buffered into a TS stream file, generate a video buffer file, based on the video file information and the assistant transcode data; and write the video buffer file into a memory.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 is a flow chart of a video file buffering method according to an embodiment of the disclosure;

FIG. 2 is a schematic structural view of a video file buffering system according to an embodiment of the disclosure;

FIG. 3 is a schematic structural view of a computer system applicable to an electronic device for implementing the video file buffering method according to the embodiment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

To address the above problems, such as undesirable buffering effect, unfriendly user experience and large resource consumption, embodiments of the present disclosure provide a video file buffering method, system and non-transitory computer-readable medium.

In the video file buffering method and system provided by the embodiments of the present disclosure, video file information and data for assisting video transcoding are stored in the memory. As such, on one hand, when a user requests to access a video file, the memory will first be searched for the video file information and the data for assisting video transcoding which if found will be read directly from the memory, thereby increasing the parsing speed as compared with reading/writing from/to a disk as before. On the other hand, because the assistant transcode data is pre-stored in the memory, transforming is no longer needed for using the data, thereby accelerating the transcoding, although part of the storage space is consumed. That is, although space is exchanged for time, the user experience is effectively improved.

Considering that there is a large need for MP4 video files, video providing websites will typically buffer those files. In the process of implementing the present disclosure, the inventor found that the ordinary manner for an existing video providing website to buffer a video file is to treat the entire video file equally. Such a manner is not ideal in terms of buffering effect. When a user requests a video file, operations are performed based on a file system. That is, the head of the file is first opened; then, part of the file is read to a disk for parsing by the server; and the parsing result (e.g., the MD5 value of the video file) and information such as beginning and ending positions of a video segment are returned to the user. Since the parsing operation is performed on the disk, the parsing speed is low and the user experience is unfriendly. Moreover, because there are many user clients, MP4 files typically need to be transcoded according to users' usage requests. That is, MP4 files are transformed into video files of such formats as FLU, TS, etc. Transcoding is very consuming in terms of CPU resources (typically, the CPU consumption is more than 99%), thereby causing a long time to be spent in transcoding and causing the user to wait such a long time.

As shown in FIG. 1, in an embodiment of the disclosure, a video file buffering method is provided, which includes the following steps.

In step S101, a buffering server acquires video file information of a video file to be buffered, the video file information including at least metadata.

Conventionally, a video file is typically segmented. This results in a large number of files which are difficult to manage, and is prone to loss of data due to some reason. In view of this, the video file mentioned in this embodiment refers to an entire video file which is not segmented.

In step S102, the buffering server generates assistant transcode data corresponding to the video file to be buffered, the assistant transcode data including at least an index file needed for transcoding the video file to be buffered into a TS stream file.

In this embodiment, the video server stores only video files of the MP4 file format, thereby significantly reducing required storage resources. This is favorable to loading and transmission of video files, particularly for P2P. Since the video server stores only video files of the MP4 format but there are various types of clients, real-time transcoding operations need to be performed upon users' requests when the files are used. That is, a MP4 file is transformed into a standard video file format such as FLV, TS, etc. For other requests, certain changes (e.g., adaptions by adapters) will be made according to users' characteristics. This needs to be supported by some assistant transcode data. For example, before it is used, a MP4 file is typically pre-processed to generate assistant transcode data. Here, the assistant transcode data includes an assistant file generated when transforming a MP4 file into a TS stream, a FLV format video file or the like, such as m3u8 which is an index file needed for transcoding a MP4 file into a TS stream. Typically, the size of m3u8 is several KBs and does not exceed 1 MB. As such, transforming is no longer needed for using the file, although part of the storage space is consumed. That is, although space is exchanged for time, the user experience is effectively improved.

In step S103, the buffering server generates a video buffer file, based on the video file information and the assistant transcode data.

In step S104, the buffering server writes the video buffer file into a memory.

Further, the video file information in step S101 includes metadata and part of frame data.

By buffering part of frame data of a video file, a user can effectively preview the video file when requesting to access the file.

The part of frame data of the video file is at least one key frame at the beginning of the video file. Typically, the beginning of the video file is the first three minutes of video content (namely, the so-called opening) during the playing of a video file. Normally, the acquired part of frame data of the video file is not large in size. As such, the user can view the opening of the requested video file.

Typically, the buffering server will set priorities for the video file information of the video file to be buffered and the assistant transcode data corresponding to the video file to be buffered. The metadata and the assistant transcode data in the video file information are given the highest priority, and the part of frame data is given the second highest priority.

Further, before acquiring the video file information of the video file to be buffered in step S101, the buffering server determines, according to a current capacity of the memory and the size of the part of frame data of the video file to be buffered, whether the acquired video file information includes the metadata or includes the metadata and the part of frame data.

When in use, the capacity of the memory is a fixed size configured by the system. For example, metadataMem=10G. According to the capacity of the memory and the usage thereof, the video file metadata and the corresponding assistant transcode data having the highest priority are written preferentially. If the memory is large enough, the part of frame data of the video file is written then. In addition, the video file metadata is written before the assistant transcode data corresponding to the video file. By way of the judging mechanism, the available memory can be effectively utilized so that the usage thereof can reach an appropriate usage rate.

Further, after writing the video buffer file into the memory in step S104, the buffering server collects access records for video buffer files in the memory and determines based on the access records whether to delete one or more of the video buffer files.

Typically, a buffer elimination strategy or algorithm known to those skilled in the art, such as a LRU algorithm, may be used for updating the buffered contents. As such, limited memory resources can be reasonably allocated and used only by regularly updating the buffer, thereby ensuring the reasonable use of buffer resources.

It shall be noted that the buffered video files are typically ordered based on how frequently they are used and are written into the memory in this order. The data written in the memory is characterized by (1) being frequently accessed and (2) being frequently subject to some processing. By storing the video file metadata, the part of frame data and the data for assisting transcoding in the memory, when a user requests to access a video file, the memory will first be searched for those data which if found will be read directly from the memory, thereby increasing the parsing speed as compared with reading/writing from/to a disk as before.

According to statistics, by buffering in advance the file needed for transcoding, the CPU consumption does not exceed 30% and is about 10% at most times. In contrast, for real-time transcoding without buffering, the CPU consumption is typically above 90%.

In the method according to the present embodiment, video file information and data for assisting video transcoding are stored in the memory. As such, on one hand, when a user requests to access a video file, the memory will first be searched for the video file information and the data for assisting video transcoding, thereby increasing the parsing speed as compared with reading/writing from/to a disk as before. On the other hand, because the assistant transcode data is pre-stored in the memory, transforming is no longer needed for using the data, thereby accelerating the transcoding so that the buffered video file can be played faster and more smoothly, although part of the storage space is consumed. That is, although space is exchanged for time, the user experience is effectively improved.

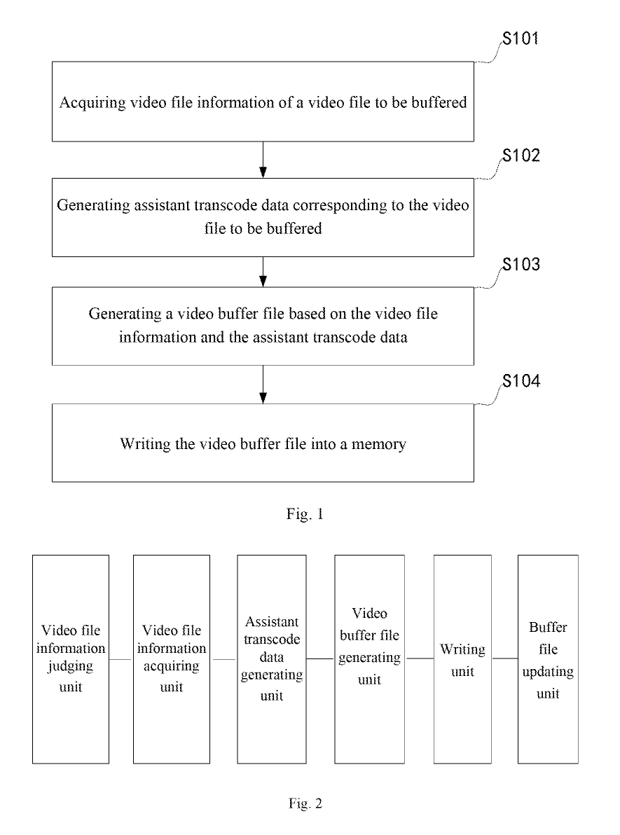

The above method related to the embodiment shown in FIG. 1 can be implemented by an apparatus according to the disclosure. Referring to FIG. 2, an embodiment of the disclosure provides a video file buffering system, including: a video file information acquiring unit configured to acquire video file information of a video file to be buffered, the video file information including at least metadata; an assistant transcode data generating unit configured to generate assistant transcode data corresponding to the video file to be buffered acquired by the video file information acquiring unit, the assistant transcode data including at least an index file needed for transcoding the video file to be buffered into a TS stream file; a video buffer file generating unit configured to generate a video buffer file, based on the video file information acquired by the video file information acquiring unit and the assistant transcode data generated by the assistant transcode data generating unit; and a writing unit configured to write the video buffer file generated by the video buffer file generating unit into a memory.

In an embodiment of the disclosure, the video file information includes the metadata and part of frame data.

Further, the part of frame data is at least one key frame at the beginning of the video file to be buffered.

The buffering server in the embodiment is a server or cluster of servers, with each module/unit being an individual server or server cluster. In this case, interaction among the modules/units appears as interaction among servers or server clusters corresponding to the modules/units. The servers or server clusters together constitute the video file buffering system of the present disclosure.

Specifically, the servers or server clusters, which together constitute the video file buffering system of the disclosure, include: a video file information acquiring server or server cluster configured to acquire video file information of a video file to be buffered, the video file information including at least metadata; an assistant transcode data generating server or server cluster configured to generate assistant transcode data corresponding to the video file to be buffered acquired by the video file information acquiring server or server cluster, the assistant transcode data including at least an index file needed for transcoding the video file to be buffered into a TS stream file; a video buffer file generating server or server cluster configured to generate a video buffer file, based on the video file information acquired by the video file information acquiring server or server cluster and the assistant transcode data generated by the assistant transcode data generating server; and a writing unit configured to write the video buffer file generated by the video buffer file generating server or server cluster into a memory.

In an alternative embodiment, some of the modules/units may together constitute a server or server cluster. For example, the video file information acquiring unit and the assistant transcode data generating unit together constitute a first server or server cluster, and the video buffer file generating unit and the writing unit together constitute a second server or server cluster.

In this case, interaction among the above modules/units appears as interaction between the first server and the second server or interaction between the first server cluster and the second server cluster, and the first server and the second server or the first server cluster and the second server cluster together constitute the video file buffering system of the disclosure.

In an embodiment of the disclosure, the system further includes: a video file information judging unit configured to determine, according to a current capacity of the memory and a preset threshold value for the part of frame data of the video file to be buffered, whether the acquired video file information includes the metadata or includes the metadata and the part of frame data, before the video file information acquiring unit acquires the video file information of the video file to be buffered.

In an embodiment of the disclosure, the system further includes: a buffer file updating unit configured to collect access records for video buffer files in the memory and determine based on the access records whether to delete one or more of the video buffer files, after the writing unit writes the video buffer file into the memory.

In an embodiment, the video file information judging unit and the buffer file updating unit may be a server or cluster of servers, with each of the video file information judging unit and the buffer file updating unit being an individual server or server cluster. In this case, interaction among the units appears as interaction among servers corresponding to the units.

The present disclosure further provides a non-transitory computer-readable storage medium, in which one or more programs including execution instructions are stored, the execution instructions being executable by electronic devices having control interfaces for executing the related steps in the above method embodiments. For example, the steps include: acquiring video file information of a video file to be buffered, the video file information including at least metadata; generating assistant transcode data corresponding to the video file to be buffered, the assistant transcode data including at least an index file needed for transcoding the video file to be buffered into a TS stream file; generating a video buffer file, based on the video file information and the assistant transcode data; and writing the video buffer file into a memory.

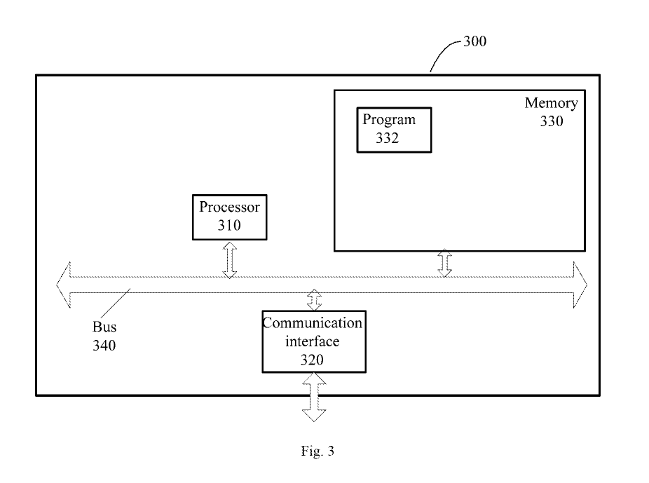

FIG. 3 is a schematic structural view of a computer system applicable to an electronic device 300 according to an embodiment of the present disclosure. The specific embodiments of the present disclosure do not define the specific implementation manners of the device 300. As shown in FIG. 3, the device 300 may include: a processor 310, a communications interface 320, a memory 330 and a communication bus 340.

Communications between the processor 310, the communications interface 320 and the memory 330 are accomplished via the communication bus 340.

The communications interface 320 is configured to communicate with a network element such as a client.

The processor 310 is configured to execute a program 332 in the memory 330, so as to execute the related steps in the above method embodiments.

In particular, the program 332 may include a program code which includes a computer operation instruction.

The processor 310 may be a Central Processing Unit (CPU), or an Application Specific Integrated Circuit (ASIC), or one or more integrated circuits configured to implement the embodiments of the present disclosure.

The memory 330 is configured to store the program 332. The memory 330 may include a high speed RAM memory, and may also include a non-volatile memory, such as at least one disk memory. The program 332 may in particular be configured to cause the device 300 to execute the following operations:

A video file information acquiring step: acquiring video file information of a video file to be buffered, the video file information including at least metadata;

An assistant transcode data generating step: generating assistant transcode data corresponding to the video file to be buffered, the assistant transcode data including at least an index file needed for transcoding the video file to be buffered into a TS stream file;

A video buffer file generating step: generating a video buffer file, based on the video file information and the assistant transcode data; and

A video buffer file writing step: writing the video buffer file into a memory.

The specific realization of each step in the program 332 can be seen from the corresponding descriptions of the corresponding steps and units in the above embodiments, and will not be described herein. It can be understood by a person skilled in the art that for the convenience and conciseness of the description, the specific working processes of the above described device and modules can be seen from the foregoing descriptions of the corresponding processes in the method embodiments, and will not be described herein.

The embodiments of the present disclosure provide a non-transitory computer-readable storage medium storing executable instructions for buffering a video file. The executable instructions, when executed by a processor, cause the processor to: acquire video file information of a video file to be buffered, the video file information comprising at least metadata, generate assistant transcode data corresponding to the video file to be buffered, the assistant transcode data comprising at least an index file needed for transcoding the video file to be buffered into a TS stream file, generate a video buffer file, based on the video file information and the assistant transcode data; and write the video buffer file into a memory.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A video file buffering method, comprising:
acquiring video file information of a video file to be buffered, wherein the video file information comprises at least metadata;
generating assistant transcode data corresponding to the video file to be buffered, wherein the assistant transcode data comprises at least an index file needed for transcoding the video file to be buffered into a Transport Stream (TS) stream file;
generating a video buffer file based on the video file information and the assistant transcode data; and
writing the video buffer file into a memory.

2. The method according to claim 1, wherein the video file information comprises the metadata and part of frame data.

3. The method according to claim 2, wherein the part of frame data is at least one key frame at the beginning of the video file to be buffered.

4. The method according to claim 2, wherein, before the video file information of the video file to be buffered is acquired, whether the acquired video file information comprises the metadata or includes the metadata and the part of frame data is determined according to a current capacity of the memory and a preset threshold value for the part of frame data of the video file to be buffered.

5. The method according to claim 1, wherein, after the video buffer file is written into the memory, access records for video buffer files in the memory are collected and whether to delete one or more of the video buffer files is determined based on the access records.

6. A video file buffering system, comprising:
at least one processor; and
a memory communicably connected with the at least one processor for storing instructions executable by the at least one processor, wherein execution of the instructions by the at least one processor causes the at least one processor to:
acquire video file information of a video file to be buffered, the video file information including at least metadata;
generate assistant transcode data corresponding to the video file to be buffered, the assistant transcode data comprising at least an index file needed for transcoding the video file to be buffered into a TS stream file;
generate a video buffer file, based on the video file information and the assistant transcode data; and
write the video buffer file into a memory.

7. The system according to claim 6, wherein the video file information comprises the metadata and part of frame data.

8. The system according to claim 7, wherein the part of frame data is at least one key frame at the beginning of the video file to be buffered.

9. The system according to claim 7, wherein the execution of the instructions by the at least one processor further causes the at least one processor to:
determine, according to a current capacity of the memory and a preset threshold value for the part of frame data of the video file to be buffered, whether the acquired video file information comprises the metadata or comprises the metadata and the part of frame data, before the video file information acquiring unit acquires the video file information of the video file to be buffered.

10. The system according to claim 6, wherein the execution of the instructions by the at least one processor further causes the at least one processor to:
collect access records for video buffer files in the memory and determine based on the access records whether to delete one or more of the video buffer files, after the writing unit writes the video buffer file into the memory.

11. A non-transitory computer-readable storage medium storing executable instructions for buffering a video file, wherein the executable instructions, when executed by a processor, cause the processor to:
acquire video file information of a video file to be buffered, the video file information comprising at least metadata;
generate assistant transcode data corresponding to the video file to be buffered, the assistant transcode data comprising at least an index file needed for transcoding the video file to be buffered into a TS stream file;
generate a video buffer file, based on the video file information and the assistant transcode data; and
write the video buffer file into a memory.

12. The non-transitory computer-readable storage medium according to claim 11, wherein the video file information comprises the metadata and part of frame data.

13. The non-transitory computer-readable storage medium according to claim 12, wherein the part of frame data is at least one key frame at the beginning of the video file to be buffered.

14. The non-transitory computer-readable storage medium according to claim 12, wherein, before the video file information of the video file to be buffered is acquired, whether the acquired video file information comprises the metadata or includes the metadata and the part of frame data is determined according to a current capacity of the memory and a preset threshold value for the part of frame data of the video file to be buffered.

15. The non-transitory computer-readable storage medium according to claim 11, wherein, after the video buffer file is written into the memory, access records for video buffer files in the memory are collected and whether to delete one or more of the video buffer files is determined based on the access records.
